(19) United States
(12) Patent Application Publication
(10) Pub. No.: US 2024/0348323 A1
(43) Pub. Date: Oct. 17, 2024

(54) COVERAGE ENHANCING DEVICES WITH FREQUENCY FILTERS

(71) Applicant: Sony Group Corporation, Tokyo (JP)

(72) Inventors: Kun ZHAO, Malmö (SE); Fredrik RUSEK, Eslöv (SE); Olof ZANDER, Södra Sandby (SE); Erik Lennart BENGTSSON, Eslöv (SE); Jose FLORDELIS, Lund (SE)

(21) Appl. No.: 18/682,925

(22) PCT Filed: Aug. 23, 2022
(86) PCT No.: PCT/EP2022/073495

§ 371 Date: Feb. 11, 2024

(30) Foreign Application Priority Data
Sep. 1, 2021 (SE) 2151092-0

(51) Int. Cl. H04B 7/155; H04W 16/26

(52) U.S. Cl. CPC H04B 7/15507; H04W 16/26

(57) ABSTRACT

Examples provide a method of operating a first communication node (CN), wherein the method comprises obtaining a capability of a coverage enhancing device (CED) to provide reconfigurable frequency filters for incident signals received along one or more input spatial directions on a radio channel and transmitted into one or more output spatial directions. determining a frequency filter to be applied by the CED; and providing, to the CED, a message indicative of the frequency filter to be applied by the CED. Further examples, provide a method of operating a CED and a second CN. Still further examples provide a first CN, a CED and a second CN configured for performing the methods.

### TECHNICAL FIELD

Various examples generally relate to communicating between nodes using coverage enhancing devices.

### BACKGROUND

In order to increase a coverage area for wireless communication, it is envisioned to use coverage enhancing devices (CEDs), particularly reconfigurable relaying devices (RRD), more particularly, reconfigurable reflective devices. Reconfigurable reflective devices are sometimes also referred to as reflecting large intelligent surfaces (LISs). See, e.g., Sha Hu, Fredrik Rusek, and Ove Edfors. “Beyond massive MIMO: The potential of data transmission with large intelligent surfaces.” IEEE Transactions on Signal Processing 66.10 (2018): 2746-2758.

An RRD can be implemented by an array of antennas that can reflect incident electromagnetic waves/signals. The array of antennas can be semi-passive. Semi-passive can correspond to a scenario in which the antennas can impose a variable phase shift and typically provide no signal amplification. An input spatial direction from which incident signals on a radio channel are accepted and an output spatial direction into which the incident signals are reflected can be reconfigured by changing a phase relationship between the antennas. Radio channel may refer to a radio channel specified by the 3GPP standard. In particular, the radio channel may refer to a physical radio channel. The radio channel may offer several time/frequency-resources for communication between different communication nodes of a communication system. An access node (AN) may transmit signals to a wireless communication device (UE) via a CED. The CED may receive the incident signals from an input spatial direction and emit the incident signals in an output spatial direction to the UE. The AN may transmit the signals using a beam directed to the CED. In some scenarios, several CEDs may be used in parallel to transmit the signals from the AN to the UE. With an increasing number of communication nodes (CN), e.g. UEs and ANs, and CEDs providing additional propagation paths, the risk that signals between two communication nodes interfere with signals between two different communication nodes increases. In particular, communication links may suffer from high intermodulation distortion (IMD).

### SUMMARY

Accordingly, there may be a need for improving communication between communication nodes using coverage enhancing devices (CEDs).

Said need is addressed with the subject matter of the independent claims. The dependent claims describe further advantageous examples. According to a first aspect, examples provide a method of operating a first CN, wherein the method comprises obtaining a capability of a CED to provide reconfigurable frequency filters for incident signals received along one or more input spatial directions on a radio channel and transmitted into one or more output spatial directions, determining a frequency filter to be applied by the CED; and providing, to the CED, a message indicative of the frequency filter to be applied by the CED.

According to a second aspect, examples provide a method of operating a CED, wherein the CED provides reconfigurable frequency filters for incident signals received along one or more spatial directions on a radio channel and transmitted into one or more output spatial directions, providing to a first CN a message indicative of the capability of the CED to provide reconfigurable frequency filters for incident signals received along one or more input spatial directions on a radio channel and transmitted into one or more output spatial directions, and/or obtaining a message indicative of a frequency filter to be applied by the CED.

According to a third aspect, examples provide a method of operating a second CN, the method comprising receiving, from a first CN, a reference signal via a CED determining a receive property of the reference signal, providing, to the first CN, a message indicative of the receive property of the reference signal, and obtaining a message indicative of a frequency filter to be applied by the CED.

Further aspects provide examples of first CNs, CEDs and second CNs comprising control circuitry for performing respective methods.

### BRIEF DESCRIPTION OF THE DRAWINGS

FIG. 1 schematically illustrates a communication system according to various examples.

FIG. 2 schematically illustrates details of the communication system according to the example of FIG. 1.

FIG. 3 schematically illustrates multiple downlink transmit beams used at a transmitter node of the communication system and further schematically illustrates a CED towards which one of the multiple transmit beams is directed according to various examples.

FIG. 4 schematically illustrates details with respect to a CED.

FIG. 5 schematically illustrates a scenario benefitting from a CED.

FIG. 6 schematically illustrates a scenario benefitting from a CED.

FIG. 7 is a signaling diagram illustrating a method of operating a first CN.

FIG. 8 schematically illustrates a scenario benefitting from a CED.

FIG. 9 schematically illustrates a scenario benefitting from a CED.

FIG. 10 is a signaling diagram illustrating a method of operating a first CN.

FIG. 11 schematically illustrates a scenario benefitting from a CED.

FIG. 12 schematically illustrates a scenario benefitting from a CED.

FIG. 13 is a signaling diagram illustrating a method of operating a CED.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)-specified cellular network (NW). In such case, the transmitter node can be implemented by an access node (AN), in particular, a base station (BS), of the RAN, and the one or more receiver nodes can be implemented by terminals (also referred to as user equipment, UE). It would also be possible that the transmitter node is implemented by a UE and the one or more receiver nodes are implemented by an AN and/or further UEs. Hereinafter, for the sake of simplicity, various examples will be described with respect to an example implementation of the transmitter node by one or more ANs and the one or more receiver node by UEs—i.e., to downlink (DL) communication; but the respective techniques can be applied to other scenarios, e.g., uplink (UL) communication and/or sidelink communication.

### Communication Via CEDs

According to various examples, the transmitter node can communicate with at least one of the receiver nodes via one or more CEDs.

The CEDs may include an antenna array. The CEDs may include a meta-material surface. In examples, the CEDs may include a reflective antenna array (RAA).

There are many schools-of-thought for how CEDs should be integrated into 3GPP-standardized RANs.

In an exemplary case, the NW operator has deployed the CEDs and is, therefore, in full control of the CEDs' operations. The UEs, on the other hand, may not be aware of the presence of any CED, at least initially, i.e., it is transparent to a UE whether it communicates directly with the AN or via the CEDs. The CEDs essentially function as a coverage-extender of the AN. The AN may have established control links with the CEDs.

According to another exemplary case, it might be a private user or some public entity that deploys the CEDs. Further, it may be that the UE, in this case, controls the CEDs' operations. The AN, on the other hand, may not be aware of the presence of any CED and, moreover, may not have control over it/them whatsoever. The UE may gain awareness of the presence of a CED by means of some short-range radio technology, such as Bluetooth, wherein Bluetooth may refer to a standard according to IEEE 802.15, or WiFi, wherein WiFi may refer to a standard according to IEEE 802.11, by virtue of which it may establish the control link with the CED. It is also possible that the UE gains awareness of the presence of a CED using UWD (Ultra wideband) communication. Using UWB may offer better time resolution due to the wider bandwidth compared to other radio technologies.

The two exemplary cases described above are summarized in TAB. 1 below.

TABLE 1
Scenarios for CED integration into cellular NW

| Scenario | Description | Explanation |
|---|---|---|
| A | AN-CED | AN controls the CED and/or can obtain |
| | control link | information from the CED. A control link is |
| | | established between the AN and the CED. |
| B | UE-CED | UE controls the CED and/or can obtain |
| | control link | information from the CED. A control link is |
| | | established between the UE and the CED. |

Hereinafter, techniques will be described which facilitate communication between a transmitter node—e.g., an AN—and one or more receiver nodes—e.g., one or more UEs—using a CED.

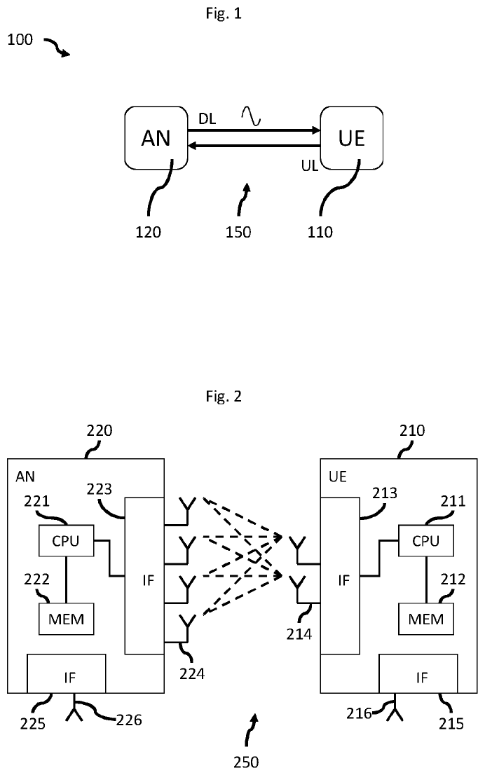

FIG. 1 schematically illustrates a communication system 100. The communication system 100 includes two nodes 110, 120 that are configured to communicate with each other via a radio channel 150. In the example of FIG. 1, the node 120 is implemented by an access node (AN) and the node 110 is implemented by a UE. The AN 120 can be part of a cellular NW (not shown in FIG. 1).

As a general rule, the techniques described herein could be used for various types of communication systems, e.g., also for peer-to-peer communication, etc. For the sake of simplicity, however, hereinafter, various techniques will be described in the context of a communication system that is implemented by an AN 120 of a cellular NW and a UE 110.

As illustrated in FIG. 1, there can be DL communication, as well as UL communication. Some examples described herein focus on the DL communication, but similar techniques may be applied to UL communication and/or sidelink communication. FIG. 2 illustrates details with respect to the AN 220. The AN 220 includes control circuitry that is implemented by a processor 221 and a non-volatile memory 222. The processor 221 can load program code that is stored in the memory 222. The processor 221 can then execute the program code. Executing the program code causes the processor to perform techniques as described herein.

Moreover, FIG. 2 illustrates details with respect to the UE 210. The UE 210 includes control circuitry that is implemented by a processor 211 and a non-volatile memory 212. The processor 211 can load program code that is stored in the memory 212. The processor can execute the program code. Executing the program code causes the processor to perform techniques as described herein.

Further, FIG. 2 illustrates details with respect to communication between the AN 220 and the UE 210 on the radio channel 250. The AN 220 includes an interface 223 that can access and control multiple antennas 224. Likewise, the UE 210 includes an interface 213 that can access and control multiple antennas 214. The UE 210 comprises a further interface 215 that can access and control at least one antenna 216 to transmit or receive a signal on an auxiliary radio channel different from the radio channel 250. Likewise, the AN 220 may comprise an additional interface 225 that can access and control at least one antenna 226 to transmit or receive a signal on the or a further auxiliary radio channel different from the radio channel. In general, the interface 225 may also be a wired interface. It may also be possible that the interface 225 is a wired or wireless optical interface. If wireless, the auxiliary radio channel may use in-band signaling or out-of-band signaling. The radio channel and the auxiliary radio channel may be offset in frequency. The auxiliary radio channel may be at least one of a Bluetooth radio channel, a WiFi channel. or an ultra-wideband radio channel. Methods for determining an angle of arrival may be provided by a communication protocol associated with the auxiliary radio channel. For example, methods for determining an angle of arrival may be provided by a Bluetooth radio channel.

While the scenario of FIG. 2 illustrates the antennas 224, 226 being coupled to the AN 220, as a general rule, it would be possible to employ transmit-receive points (TRPs) that are spaced apart from the AN 220.

The interfaces 213, 223 can each include one or more transmitter (TX) chains and one or more receiver (RX) chains. For instance, such RX chains can include low noise amplifiers, analogue to digital converters, mixers, etc. Analogue and/or digital beamforming would be possible.

Thereby, phase-coherent transmitting and/or receiving (communicating) can be implemented across the multiple antennas 214, 224. Thereby, the AN 220 and the UE 210 can selectively transmit on multiple TX beams (beamforming), to thereby direct energy into distinct spatial directions.

By using a TX beam, the direction of the wavefront of signals transmitted by a transmitter of the communication system is controlled. Energy is focused into a respective direction or even multiple directions, by phase-coherent superposition of the individual signals originating from each antenna 214, 224. Energy may also be focused to a specific point (or limited volume) at a specific direction and a specific distance of the transmitter. Thereby, a data stream may be directed in multiple spatial directions and/or to multiple specific points. The data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams. it is possible to employ receive (RX) beams.

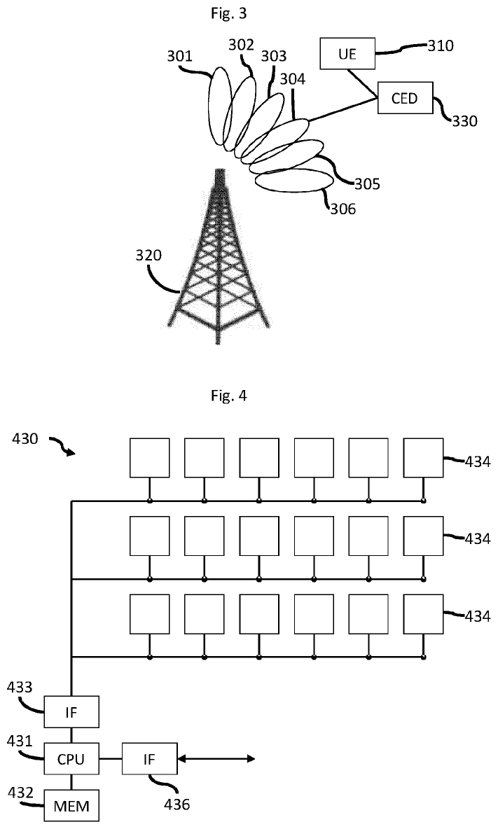

FIG. 3 illustrates DL TX beams 301-306 used by the AN 320. Here, the AN 320 activates the beams 301-306 on different resources (e.g., different time-frequency resources, and/or using orthogonal codes/precoding) such that the UE 310 can monitor for respective signals transmitted on the DL TX beams 301-306.

It is possible that the AN 320 transmits signals to the UE 310 via a CED 330. In the scenario of FIG. 3, the downlink transmit beam 304 is directed towards the CED 330. Thus, whenever the AN 320 transmits signals to the UE 310 using the downlink transmit beam 304—e.g., a respective block of a burst transmission—, a spatial filter is provided by the CED 330. The spatial filter is associated with a respective spatial direction into which the incident signals are then selectively reflected by the CED 330. Details with respect to the CED 330 are illustrated in connection with FIG. 4.

FIG. 4 illustrates aspects in connection with the CED 430. The CED 430 includes a phased array of antennas 434 that impose a configurable phase shift when reflecting incident signals. This defines respective spatial filters that may be associated with spatial directions into which the incident signals are reflected. The antennas 434 can be passive or semi-passive elements. The CED 430 thus provides coverage extension by reflection of radio-frequency (RF) signals. A translation to the baseband may not be required. This is different to, e.g., decode-and-forward repeaters or regenerative functionality. The antennas 434 may induce an amplitude shift by attenuation. In some examples, the antennas 434 may provide forward amplification with or without translation of signals transmitted on the radio channel to the baseband. In some examples, the CEDs may be configurable to shift power from one polarization to the orthogonal polarization. The antennas 434 may amplify and forward the signals.

The CED 430 includes an antenna interface 433, which controls an array of antennas 434; a processor 431 can activate respective spatial filters one after another. The CED 430 further includes an interface 436 for receiving and/or transmitting signals on an auxiliary radio channel. The interface 436 may be a wireless interface. In some examples, the auxiliary radio channel may be replaced with a wired auxiliary channel and the interface 436 may be a wired interface. There is a memory 432 and the processor 431 can load program code from the non-volatile memory and execute the program code. Executing the program code causes the processor to perform techniques as described herein.

FIG. 4 is only one example implementation of a CED. Other implementations are conceivable. For example, a meta-material surface not including distinct antenna elements may be used. The meta-material can have a configurable refraction index. To provide a reconfigurable refraction index, the meta-material may be made of repetitive tunable structures that have extensions smaller than the wavelength of the incident RF signals.

### Improving Communication on a Radio Channel With Coverage Enhancing Devices (CEDs) Performing Frequency Filtering

FIG. 5 illustrates an exemplary scenario B as described hereinbefore with reference to TAB. 1. An AN 510 is to communicate with a first UE 521 and a second UE 522 over a radio channel. The radio channel may be a 5G NR channel, in particular, a 5G NR channel in Frequency Range 2 or beyond. It is also conceivable that the radio channel is a 3GPP channel belonging to the frequency range from 7 to 24 GHz.

The communication between the AN 510 and the first UE 521 may involve using a physical propagation path 591 from the first UE 521 to a CED 530 and a physical propagation path 592 from the CED 530 to the AN 510.

As described hereinbefore, the CED 530 may be semi-passive and free of circuitry for encoding and decoding signals transmitted over the radio channel. The CED 530 may provide multiple spatial filters, wherein each one of the multiple spatial filters is associated with a respective input spatial direction from which incident signals on a radio channel are accepted and with a respective output spatial direction into which the incident signals are reflected by the CED.

Communication between the AN 510 and first UE 521 along the propagation paths 591, 592 may be intended to occur only on the two central frequency resources of the six frequency resources schematically indicated in FIG. 5. However, due to technical constraints there may still occur some out-of-band transmission from the first UE 521. For example, there may be some transmission on the two lowest and highest frequencies as indicated in FIG. 5.

The communication between the AN 510 and the second UE 522 may be intended to be performed using the two highest frequency resources as indicated next to the propagation path 593.

Due to the unintentional transmission of the first UE 521 on out-of-band frequencies, intermodulation distortion (IMD) may occur at the AN 510 causing communication performance degradation.

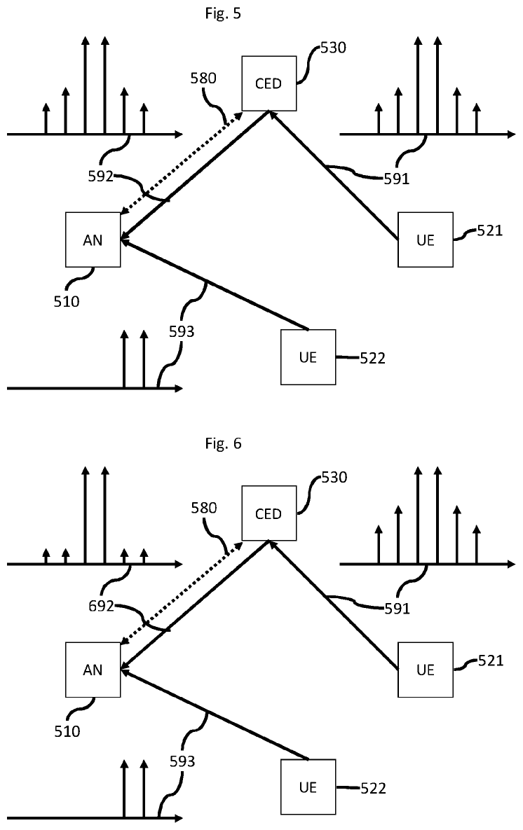

As shown in FIG. 6 the CED 530 may apply a frequency filter on the incident signal received from the first UE 521 via the propagation path 591 before transmitting the incident signal to the AN 510 via the propagation path 692. In particular, the frequency filter may be applied to suppress the transmission on the out-of-band frequency resources. Accordingly, an interference of the signals received via the propagation path 692 and via the propagation path 593 may be avoided. Thus, the channel quality of the transmission channel between the first UE 521 and the AN 510 and/or the channel quality of transmission channel between the second UE 522 and the AN 510 may be improved.

Generally, a frequency filter as mentioned in the disclosure may correspond to a low pass filter substantially attenuating, in particular blocking, frequencies above a certain cutoff-frequency, to a high pass filter substantially attenuating, in particular blocking, frequencies below a certain cutoff-frequency, to a band-stop filter substantially attenuating, in particular blocking, frequencies above a first cutoff-frequency and below a second cutoff-frequency, or to a combination thereof.

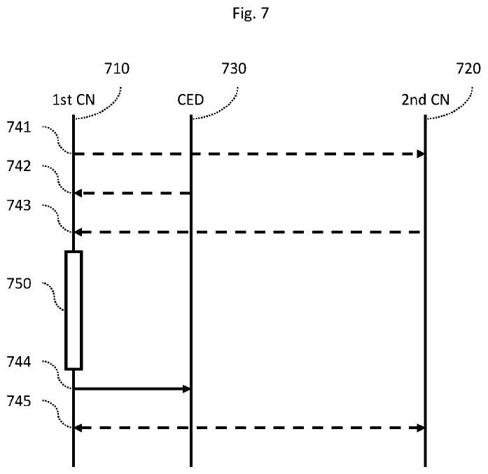

FIG. 7 is an exemplary signaling diagram illustrating a method of operating a first CN 710, wherein dashed signals are optional. The first CN 710 may be configured for controlling a CED 730. The first CN 710 may be implemented by an AN 510 as shown in FIGS. 5 and 6. However, in other examples the first CN 710 may also be implemented by a UE. The CED may provide reconfigurable frequency filters for incident signals received along one or more spatial directions on a radio channel and transmitted into one or more output spatial directions.

The first CN 710 may optionally provide a message 741, to a second CN 720, indicative of uplink resources to be used by the second CN 720 for transmitting signals on a radio channel to the first CN 710. In some examples, the second CN 720 may be implemented by a UE, for example by the UE 521 shown in FIGS. 5 and 6. In other examples, the second CN 720 may be implemented by an AN.

Optionally, the first CN 710 may obtain a message 742 indicative of the capability of the CED 730 to provide reconfigurable frequency filters for incident signals received along one or more spatial directions on a radio channel and transmitted into one or more output spatial directions. The first CN 710 may obtain the message 742 from the CED 730. In other examples, information on the capability of the CED 730 may be obtained by other means. For example, the first CN 710 may be aware that every CED to be used within the network may have said capability. Thus, transmitting a dedicated message providing information on the capability of the CED may be avoided freeing resources for other transmissions. On the other hand, providing such a message may allow for using CEDs with different capabilities in a network. The message 742 may be obtained after or before providing the message 741.

The second CN 720 may transmit a reference signal 743 to the first CN 710 on a radio channel. For example, the second CN 720 may use the resources indicated with message 741 for transmitting the reference signal 743. The reference signal 743 may be a dedicated reference signal for determining intermodulation distortion (IMD) or a reference signal already used for different purposes. In some examples. a regular data signal may be used as a reference signal 743.

At box 750, the first CN 710 may determine a receive property of the reference signal 743. For example, the first CN 710 may perform an interference measurement using the reference signal 743. The reference signal 743 may include a zero power (ZP) transmission. In response to obtaining the receive property of the reference signal 743, the first CN 710 may determine a frequency filter to be applied by the CED 730.

The first CN 710 provides a message 744 indicative of the frequency filter to be applied by the CED 730 to the CED 730. The message 744 indicative of the frequency filter to be applied by the CED 730 may also be considered as a stop band configuration. The CED 730 applies the respective frequency filter. Thereafter, signals 745 carrying payload data may be exchanged on the radio channel between the first CN 710 and the second CN 720.

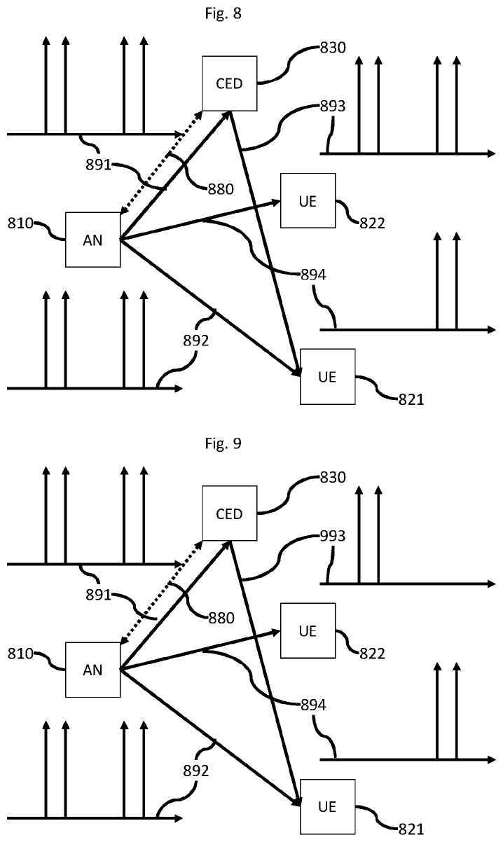

FIGS. 8 and 9 illustrate a further scenario. in which a CED 830 providing reconfigurable frequency filters for incident signals received along one or more input spatial directions on a radio channel and transmitted into one or more output spatial directions may be useful. An AN 810 may communicate with a first UE 821 and a second UE 822. The AN 810 is configured for controlling the CED 830 via a channel 880. The channel 880 may be different from the radio channel used for transmitting signals between the AN 810, the first UE 821 and the second UE 822.

Communication with the first UE 821 may involve transmitting signals on a radio channel along a physical propagation path 891 to the CED 830 and a physical propagation path 893 from the CED 830 to the first UE 821 as well as along a further physical propagation path 892 from the AN 810 to the first UE 821. In particular, the propagation path 892 may be a line-of-sight (LOS) propagation path.

Further, signals may be transmitted from the AN 810 to the second UE 822 using the propagation path 894.

Transmitting signals on the radio channel from the AN 810 to the first UE 821 may involve using the two lowest and the two highest of six available frequency resources and transmitting signals on the radio channel from the AN 810 to the second UE 822 may involve using the two highest of six available frequency resources.

The second UE 822 may be close to the propagation path 893. Accordingly, there may be interference between the signals intended for the first UE 821 and the second UE 822 as both use the two highest of six available frequency resources. Said interference may negatively influence communication performance.

As shown in FIG. 9, the CED 830 may apply a frequency filter. Thus, on the propagation path 993 the signal from the AN 810 to the first UE 821 may no longer be transmitted on the two highest frequency resources. Accordingly, interference with the signal from the AN 810 to the second UE 822 may be avoided and communication performance improved. However, on the propagation path 892 all frequency four frequency resources may still be used. Thus. the communication performance between the AN 810 and the first UE 821 may still be better than using only two frequency resources.

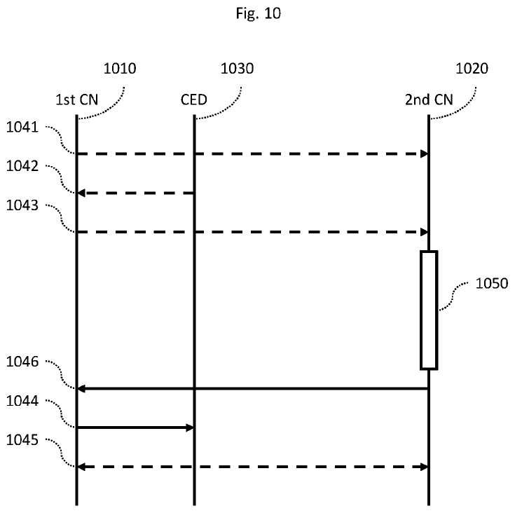

FIG. 10 is an exemplary signalling diagram illustrating a further method of operating a first CN 1010, wherein dashed signals are optional. The CED 1030 may be controlled by the first CN 1010. The first CN 1010 may be implemented by an AN 1010 as shown in FIGS. 8 and 9. According to further examples, the first CN 1010 may be implemented by a UE, too. The CED 1030 may provide reconfigurable frequency filters for incident signals received along one or more spatial directions on a radio channel and transmitted into one or more output spatial directions.

The second CN 1020 may optionally obtain, in particular from the first CN 1010, a message 1041 of downlink resources to be used by the second CN 1020 for receiving reference signals (e.g., CSI-RS) on a radio channel. In some examples, the second CN 1020 may be implemented by a UE, for example by the UE 821 shown in FIGS. 8 and 9. In other examples, the second CN 1020 may be implemented by an AN.

In some examples, the CED 1030 may provide a message 1042 indicative of the capability of the CED 1030 to provide configurable frequency filters for incident signals received along one or more spatial directions on a radio channel and transmitted into one or more output spatial directions. Information on the capability of the CED 1030 may be provided by different means, too. For example, the capability of the CED 1030 may be known to the network.

The message 1041 may be provided before or after obtaining the message 1042.

The second CN 1020 may receive a reference signal 1043 from the first CN 1010 on a radio channel. In examples, the second CN 1020 may use the resources indicated by the message 1041 for receiving the reference signal 1043. The reference signal 1043 may be a dedicated reference signal for determining IMD or a reference signal already used for different purposes (e.g., CSI-RS). It may also be conceivable, to use a regular data signal as reference signal 1043. The reference signal 1043 may include ZP transmissions.

As indicated with box 1050, the second CN 1020 may determine a receive property of the reference signal 1043. In particular, the second CN 1020 may perform an interference measurement using the reference signal 1043.

The first CN 1010 obtains a message 1046 indicative of the receive property of the reference signal 1043. In particular, the receive property may comprise information on interference on the radio channel. Providing the message 1046 may also be considered as interference reporting.

The first CN 1010 determines a frequency filter to be applied by the CED 1030 in response to obtaining the receive property of the reference signal 1043 and provides, to the CED 1030, a message 1045 indicative of the frequency filter to be applied by the CED 1030. The CED 1030 applies the respective frequency filter and, afterwards, signals 1045 carrying payload data may be exchanged on the radio channel between the first CN 1010 and the second CN 1020 with optimized quality.

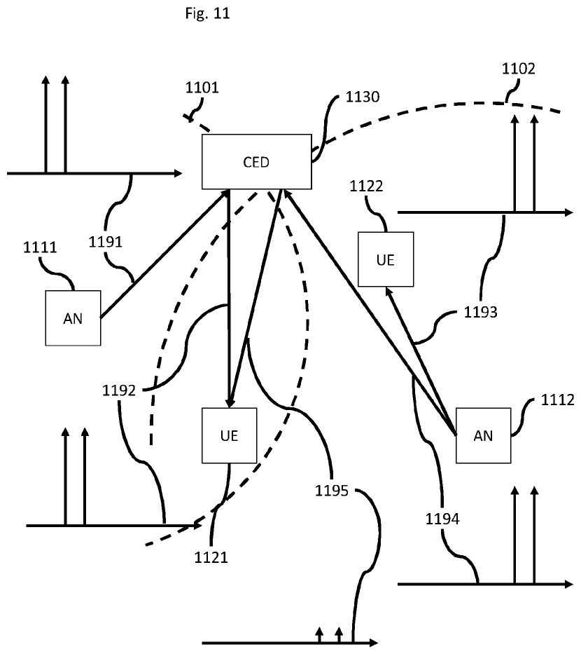

FIG. 11 illustrates a still further scenario, in which communication may be improved by using a CED 1130. The scenario involves a first cell 1101 and a second cell 1102. A first AN 1111 may be associated with the first cell 1101 and a second AN 1112 may be associated with the second cell 1102. The CED 1130 may provide a propagation path 1191, 1192 from the first AN 1111 to the first UE 1121 as well as an (unintended) propagation path 1194, 1195 from the second AN 1112 to the first UE 1121.

The CED 1130 may be controlled by the first AN 1111 to apply a frequency filter blocking frequencies associated with the second cell 1102. Applying the frequency filter may avoid that the reflected signal from the neighbouring second cell 1102 reaches the first UE 1121. Thus, the risk of interferences between the first cell 1101 and the second cell 1102 may be reduced. In other words, the CED may help to reduce inter-cell interferences, in particular if the CED 1130 is within reach of a first cell 1101 and a second cell 1102.

When the first cell 1101 and the second cell 1102 use different frequencies of the radio channel, the CED 1130 may be configured to apply a frequency filter blocking the frequencies associated with the second cell 1102. Similar signalling as described with respect to FIG. 7 may be used. In particular, the first AN 1111 may provide a message indicative of the frequency filter to be applied by the CED 1130.

Determining the frequency filter to be applied by the CED may comprise obtaining the frequency filter from a database. For example, different cells of a network may use different frequencies for transmitting signals. The network may comprise a database indicative of the frequencies to be used by the respective cells. An AN may determine, based on the database, which frequencies to use. Based on the frequencies to be used, the AN may provide a message to a CED of the cell indicative of the frequency filter to be applied by the CED.

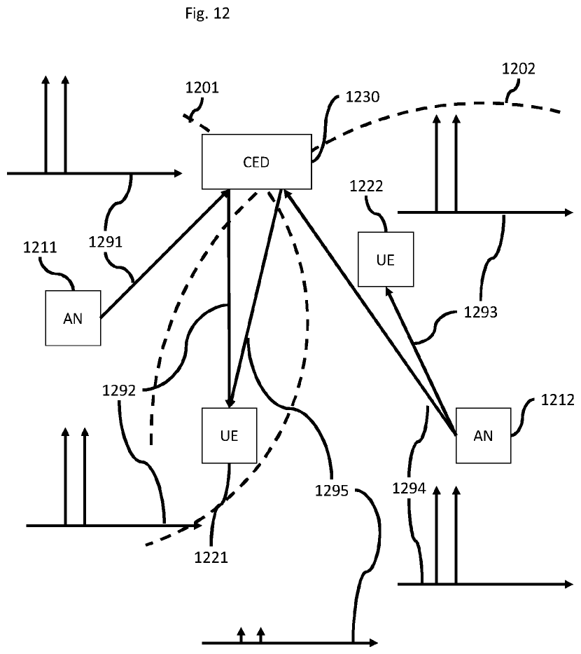

Another scenario benefitting from a CED 1230 providing reconfigurable frequency filters for incident signals received along one or more input spatial directions on a radio channel and transmitted into one or more output spatial directions is shown in FIG. 12. The scenario of FIG. 12 is similar to the scenario of FIG. 11. In contrast to the scenario of FIG. 11, the same frequency resources are to be used for exchanging signals on a radio channel in the first cell 1101 and the second cell 1102. Thus, the first AN 1211 may use the same frequency resources to transmit a signal via propagation paths 1291, 1292 to the first UE 1221 as the second AN 1212 for transmitting signals to the second UE 1222 via the propagation path 1293. The CED 1230 may be controlled to apply a frequency filter depending on the angle of arrival of the incident signal or the angle of departure of the transmitted incident signal. In the example shown in FIG. 12, the CED 1230 may apply a frequency filter for an incident signal arriving via the propagation path 1294. Accordingly, the first UE 1221 may receive signals via the propagation path 1292 essentially without an interference of signals arriving via the propagation path 1295. In some examples, the CED 1230 may autonomously determine that it is used by two cells and may apply a different frequency filter depending on the cell. In other examples. the CED 1230 may be controlled by a CN observing that the CED 1230 is used by two cells.

Thus, in some examples applying a frequency filter for incident signals received, by the CED, along one or more input spatial directions on a radio channel and transmitted into one or more output spatial directions may involve applying the frequency filter irrespectively of the input and/or output spatial direction. This may reduce the complexity of controlling the CED. According to further examples, applying a frequency filter may involve applying a frequency filter depending on an input and/or output spatial direction. A frequency filter may be associated with at least one spatial filter. The CED may provide multiple spatial filters, each one of the multiple spatial filters being associated with at least one of the one or more input spatial directions from which incident signals on a radio channel are accepted and with at least one of the one or more output spatial directions into which the incident signals are transmitted by the CED. This may allow for a better adaption of the CED to particular employment scenarios of the CED.

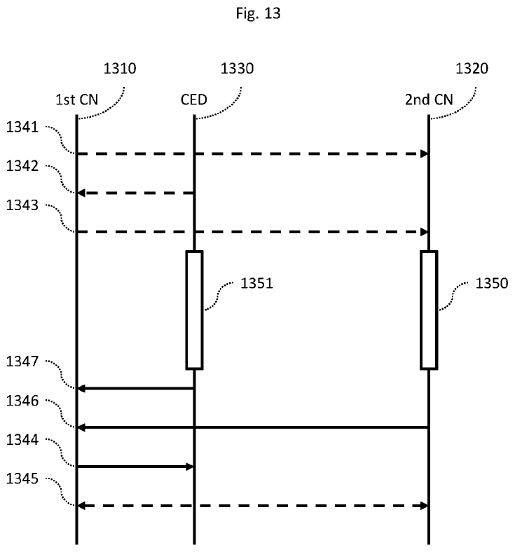

FIG. 13 shows a signalling diagram which may be used for implementing a method of controlling a CED 1330. The CED 1330 may provide reconfigurable frequency filters for incident signals received along one or more spatial directions on a radio channel and transmitted into one or more output spatial directions.

A first CN 1310 may provide a message 1341 to a second CN 1320 indicative of downlink resources for receiving a reference signal. The first CN 1310 may be implemented by an AN 1210 as shown in FIG. 12. The CED 1330 may provide a message 1342 indicative of the capability of the CED 1330 to provide reconfigurable frequency filters for incident signals received along one or more spatial directions on a radio channel and transmitted into one or more output spatial directions. The message 1342 may be provided after or before the message 1341. In other examples, information on the capability of the CED 1330 may be provided to the first CN 1310 by other means. The second CN 1320 may receive a reference signal 1343. At box 1350, the second CN 1320 may determine a receive property of the reference signal 1343. For example, the second CN 1320 may perform an interference measurement using the reference signal 1343. The second CN 1320 provide a message 1346 indicative of the receive property of the reference signal 1343 to the first CN 1310.

The CED 1330 determines an interference situation as well as indicated with box 1351. For example, the CED 1330 may determine that it also receives signals from a direction not associated with the first CN 1310, but with a further CN, for example, with a CN associated with another cell. Thus, the CED 1330 may determine that a receive property of a reference signal may be compromised. Accordingly, the CED 1330 also provides a message 1347 indicative of a receive property to the first CN 1310.

The first CN 1310 may determine a frequency filter to be applied by the CED 1330 in response to receiving the message 1346, 1347. The CED 1330 may obtain a message 1344 indicative of the frequency filter to be applied from the first CN 1310 and apply the frequency filter. Afterwards, the first CN 1310 and the second CN 1320 may include signals via the CED 1330 on the radio channel, wherein the signals comprise payload data. In the example of FIG. 13, both the CED 1330 and the second CN 1320 provide a message indicative of a receive property. However, it is also conceivable that only the CED 1330 or only the second CN 1320 provides such a message. It may also be possible that the first CN 1310 only considers one of the two messages for determining the frequency filter.

1. A method of operating a first communication node (CN) wherein the method comprises;
obtaining a capability of a coverage enhancing device (CED) to provide reconfigurable frequency filters for incident signals received along one or more input spatial directions on a radio channel and transmitted into one or more output spatial directions,
determining a frequency filter to be applied by the CED; and
providing, to the CED, a message indicative of the frequency filter to be applied by the CED.

2. The method of operating the first CN of claim 1,
wherein determining the frequency filter to be applied by the CED comprises obtaining the frequency filter from a database.

3. The method of operating the first CN of claim 1, further comprising:
determining the frequency filter to be applied by the CED in response to obtaining a receive property of a reference signal.

4. The method of operating the first CN according to claim 1,
wherein obtaining the capability of the CED comprises obtaining, in particular from the CED, a message indicative of the capability of the CED.

5. The method of operating the first CN according to claim 1, wherein the method comprises:
receiving, from a second CN, the reference signal on the radio channel, and determining the receive property of the reference signal.

6. The method of operating the first CN of claim 1, wherein the method comprises:
obtaining at least one message indicative of the receive property of the reference signal.

7. The method of operating the first CN of claim 6,
wherein the method comprises obtaining a message indicative of the receive property of the reference signal from the CED.

8. The method of operating the first CN of claim 6, wherein the method comprises:
obtaining a message indicative of the receive property of the reference signal from a second CN.

9. The method of operating the first CN of claim 8, wherein the method further comprises:
transmitting, to the second CN, the reference signal on the radio channel.

10. The method of operating the first CN of claim 1,
wherein the receive property comprises information on interference on the radio channel.

11. The method of operating the first CN of claim 1,
wherein obtaining a capability of the CED to provide reconfigurable frequency filters comprises obtaining a capability of the CED to provide multiple spatial filters, each one of the multiple spatial filters being associated with at least one of the one or more input spatial directions from which incident signals on a radio channel are accepted and with at least one of the one or more output spatial directions into which the incident signals are transmitted by the CED,
wherein the message indicative of the frequency filter is indicative of a spatial filter.

12. A method of operating a coverage enhancing device (CED),
wherein the CED provides reconfigurable frequency filters for incident signals received along one or more spatial directions on a radio channel and transmitted into one or more output spatial directions,
providing to a first communication node (CD) a message indicative of the capability of the CED to provide reconfigurable frequency filters for incident signals received along one or more input spatial directions on a radio channel and transmitted into one or more output spatial directions, and/or
obtaining a message indicative of a frequency filter to be applied by the CED.

13. The method of operating the CED of claim 12,
wherein the message indicative of the capability of the CED to provide reconfigurable frequency filters is indicative of a capability of the CED to provide multiple spatial filters, each one of the multiple spatial filters being associated with at least one of the one or more input spatial directions from which incident signals on a radio channel are accepted and with at least one of the one or more output spatial directions into which the incident signals are transmitted by the CED, and
wherein the message indicative of the frequency filter is indicative of a spatial filter.

14. A method of operating a second communication node (CN) the method comprising:
receiving, from a first CN, a reference signal via a coverage enhancing device, CED,
determining a receive property of the reference signal, and
providing, to the first CN, a message indicative of the receive property of the reference signal,
obtaining a message indicative of a frequency filter to be applied by the CED.

15. A first communication node (CN) wherein the first CN comprises control circuitry configured for performing the method of claim 1.

16. A coverage enhancing device (CED) wherein the CED comprises control circuitry configured for performing the method of claim 12.

17. A second communication node (CN) wherein the second CN comprises control circuitry configured for performing the method of claim 14.
